(19) United States
(12) Patent Application Publication
(10) Pub. No.: US 2022/0372244 A1
(43) Pub. Date: Nov. 24, 2022

(54) FLAME RETARDANT POLYSILOXANE COMPOSITION

(71) Applicant: Dow Silicones Corporation, Midland, MI (US)

(72) Inventors: Yan Huang, Shanghai (CN); Dorab Bhagwagar, Auburn, MI (US); Zhongwei Cao, Shanghai (CN)

(21) Appl. No.: 17/763,232

(22) PCT Filed: Nov. 25, 2019
(86) PCT No.: PCT/CN2019/120546

§ 371 Date: Mar. 24, 2022

(51) Int. Cl. C08K 3/22

(52) U.S. Cl. CPC C08K 3/22; C08K 2003/2296; C08K 2201/005

(57) ABSTRACT

A composition contains (a) a polysiloxane; and (b) 0.15 weight-percent or more and 85 weight-percent of less, relative to composition weight dispersed in the polysiloxane, of zinc oxide particles having an average particle size of less than one micrometer and greater than one nanometer as determined as the volume weighted median value of particle diameter distribution using a laser diffraction particle size analyzer.

### BACKGROUND OF THE INVENTION

### Field of the Invention

The present invention relates to a polysiloxane composition comprising nano-sized zinc oxide particles that achieves a V0 rating in UL 94 testing.

### Introduction

It is desirable to improve the flame retardant properties of polysiloxane compositions. In particular, it is desirable to achieve a polysiloxane composition that achieves a V0 rating in UL94 testing. Approaches to improving flame retardant properties of polysiloxane compositions include incorporation of halogenated flame retardants at loadings of 10 weight-percent or more, metal hydrides at concentration of greater than 30 volume-percent, transition metal complexes as loadings of at least one weight-percent, or intumescent components that comprise a blend of a binder, blowing agent and acid source into the polysiloxane polymer composition (see, for example, Timpe, David C., Rubber and Plastics News, Presented at the 2007 Hose Manufacturers Conference, Jun. 11-12, 2007, Cleveland, Ohio).

However, it would be an advance in the art to identify an additive that can improve the flame retardant properties of polysiloxane polymer compositions sufficiently to achieve a V0 rating in UL 94 testing without having to add intumescent components or the aforementioned concentrations of additives.

### BRIEF SUMMARY OF THE INVENTION

The present invention provides a solution to achieving a V0 rating in UL 94 testing for polysiloxane compositions without having to add intumescent components, 10 weight-percent (wt %) or more halogenated flame retardants, 30 volume-percent (vol %) or more metal hydrides or one wt % or more transition metal complexes.

Surprisingly, it has been unexpectedly discovered that including 0.15 weight-percent or more of zinc oxide (ZnO) powder that has an average particle size of less than one micrometer in polysiloxane polymer composition provides sufficient flame retardant properties to the composition to enable it to achieve a V0 rating in UL 94 testing—without requiring intumescent compositions, 10 wt % or more halogenated flame retardants, 30 vol % or more metal hydrides or one wt % or more transition metal complexes. Notably, other metal oxide powders are shown to be unable to achieve the same effect as the ZnO powder.

In a first aspect, the present invention is a composition comprising: (a) a polysiloxane; and (b) 0.15 weight-percent or more and 85 weight-percent of less, relative to composition weight dispersed in the polysiloxane, of zinc oxide particles having an average particle size of less than one micrometer and greater than one nanometer as determined as the volume weighted median value of particle diameter distribution using a laser diffraction particle size analyzer

The present invention is useful, for example, in polysiloxane sealants and coatings formulations as well as encapsulant or gap fillers in electronics.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to American Society for Testing and Materials; EN refers to European Norm; DIN refers to Deutsches Institut für Normung; ISO refers to International Organization for Standards; and UL refers to Underwriters Laboratory.

Products identified by their tradename refer to the compositions available under those tradenames on 1 Oct. 2019.

“Multiple” means two or more. “And/or” means “and, or as an alternative”. All ranges include endpoints unless otherwise indicated. Unless otherwise stated, all weight-percents (wt %) are relative to composition weight and all volume-percents (vol %) are relative to composition volume. Unless otherwise stated, molecular weights are number-average molecular weight in Daltons determined by gel permeation chromatography using 100 microliter injection of a 15 milligram per milliliter concentration of sample onto a Polymer Labs PLgel 5 micrometer guard column (50 millimeters by 7.5 millimeters) followed by two Polymer Labs PLgel 5 micrometer Mixed-C columns (300 millimeters by 7.5 millimeters) using tetrahydrofuran eluent at one milliliter per minute flow rate, a differential refractive index detector at 35° C. and 16 narrow polystyrene standards spanning a molecular weight range of 580 Da through 2,300 Da.. Viscosities are measured at 25° C. at 0.1 to 50 RPM on a Brookfield DV-III cone & plate viscometer with #52 spindle.

The present invention is a composition that comprises a polysiloxane and a zinc oxide (ZnO) particles dispersed in the polysiloxane.

The ZnO particles are characterized by having an average particle size of less than one micrometer, preferably 0.90 micrometers or less, more preferably 0.80 micrometers or less, 0.70 micrometers or less, 0.60 micrometers or less, 0.50 micrometers or less and can be 0.40 micrometers or less, 0.30 micrometers or less, 0.25 micrometers or less, 0.20 micrometers or less, 0.15 micrometers or less and at the same time having an average particle size of greater than one nanometer, preferably 0.01 micrometers or more, 0.02 micrometers or more, 0.03 micrometers or more, 0.04 micrometers or more, 0.05 micrometers or more and even 0.10 micrometer or more. Determine average particle size for particles herein as the volume-weighted median value of particle diameter distribution (D50) using a Mastersizer™ 3000 laser diffraction particle size analyzer from Malvern Instruments.

Surprisingly, it has been discovered that when the ZnO particles have an average particle size of one micrometer or greater they are dramatically less effective at imparting flame retardant properties to the polysiloxane composition than ZnO particles having an average particle size in the smaller presently specified range. For practical purposes in handling and dispersing during formulating, the average particle size is desirably greater than one nanometer.

The ZnO particles can be surface treated or be free of surface treatment. It can be desirable to use ZnO particles having a surface treatment that facilitates dispersing in the polysiloxane or polysiloxane precursors (for reactive systems). However, the flame retarding properties imparted by the ZnO particle does not require a surface treatment on the ZnO particles. For example, the ZnO can be free of tetraalkoxy silane and/or a partial hydrolysis-condensation product thereof. Moreover, the entire composition can be free of ZnO particle having a coating of tetraalkoxy silane and/or a partial hydrolysis-condensation product thereof. In fact, the composition can be free of tetraalkoxy silane and/or a partial hydrolysis-condensation products thereof.

The ZnO particles can be free of atoms other than zinc and oxygen. For example, the ZnO particles can be free of silicon dioxide (SiO₂) as is present in ZnO/SiO₂ composite particles.

The ZnO particles are present in the composition at a concentration of 0.15 wt % or more, and can be present at a concentration of 0.20 wt % or more, 0.25 wt % or more, 0.30 wt % or more, 0.40 wt % or more, 0.50 wt % or more, 0.60 wt % or more, 0.75 wt % or more, 1.0 wt % or more 1.25 wt % or more, 1.50 wt % or more, 1.75 wt % or more, 2.0 wt % or more, 2.5 wt % or more, 3.0 wt % or more, 3.5 wt % or more, 4.0 wt % or more, even 4.5 wt % or more. If the ZnO particles are present at a concentration below 0.15 wt % then they will not impart sufficient flame retardant properties to the silicon composition (in the absence of other flame retardants) to enable the composition to achieve a V0 rating in UL94 testing. There is no known upper limit to the amount of ZnO particles needed to achieve a V0 rating in UL94 testing because typically the more ZnO present, the better the fire retardant performance. Practically speaking, at that same time the ZnO particles are present at one of the lower limit concentrations stated herein, the ZnO particles are present at a concentration of 95 wt % or less, 90 wt % or less, 80 wt % or less, 70 wt % or less, 60 wt % or less, 50 wt % or less, 40 wt % or less, 30 wt % or less, 25 wt % or less, 20 wt % or less, 15 wt % or less, 10 wt % or less, 5 wt % or less, 4.5 wt % or less, 4.0 wt % or less, 3.5 wt % or less, 3.0 wt % or less, 2.5 wt % or less, 2.0 wt % or less, 1.5 wt % or less or even 1.0 wt % or less. Wt % is relative to composition weight.

The ZnO particles are dispersed into a polysiloxane. A “polysiloxane” is a polymer comprising multiple siloxane units along its backbone. Siloxane units are typically identified as “M-type” having a general structure of (R₃SiO_{1/2}), “D-type” having a general structure of (R₂SiO_{2/2}), “T-type” having a general structure of (R₁SiO_{3/2}), and “Q-type” having a general structure of (SiO_{4/2}). The subscript on the oxygen indicates how many oxygen bonds are bound to the silicon atom—with the other half of the bonds bound to a moiety other than the siloxane unit. Each “R” group is independently selected from hydrogen and/or carbon containing moieties such as, for example, hydrogen, hydroxyl, a hydrocarbyl groups (such as methyl and phenyl), a substituted hydrocarbyl groups, an alkoxy groups, and substituted alkoxy groups. Some typical R groups include hydrogen, methyl, and phenyl.

In the broadest anticipated technical scope of the invention, the polysiloxane is without limit and contain any combination of siloxane units and R components on those siloxane units. The polysiloxane is desirably a reactive polysiloxane, which means that the polysiloxane includes reactive groups such as silanol and/or carbon-carbon unsaturated groups (e.g., alkene or alkyne groups). For instance, the polysiloxane can be a reactive polysiloxane that comprises any one or any combination of more than one functional group selected from a group consisting of silanol groups, alkoxy groups, epoxy groups, groups containing carbon-carbon unsaturated bonds and silyl hydride groups.

The polysiloxane can be part of a reactive system. Desirably, the polysiloxane is a reactive polysiloxane in a reactive system that includes components that can react with the polysiloxane. A reactive system is a set of reactants than can undergo a chemical reaction for form a reaction product. For example, a reactive system can comprise a reactive polysiloxane that reacts with one or more other component to form a reaction product. Any of the one or more other components can also be a polysiloxane. The ZnO can be dispersed in one or more than one polysiloxane of the reactive system to form a composition of the present invention. The polysiloxane can also be the reaction product of a reaction system. When the ZnO particles are dispersed in a polysiloxane of a reaction system it is common for the ZnO particles to be dispersed in the reaction product of the reaction system—which is also a polysiloxane. The present invention is particularly valuable in the form of reactive systems and reaction products of reaction systems to impart flame retardant properties to caulks, sealants, coatings, encapsulants and adhesives that are polysiloxane reaction products of reactive systems, reactive systems that themselves typically comprise one or more than one polysiloxane.

One example of a reactive system example of a reactive system that can contain polysiloxanes and/or that can generate polysiloxane reaction products is a hydrosilylation reaction system, which produces a hydrosilylation reaction product. A hydrosilylation reaction system comprises a reactant (typically a reactive polysiloxane) with a silyl hydride functionality and a reactant (the same or different reactive polysiloxane as the one with the silyl hydride functionality) with a carbon-carbon unsaturated bond (typically, a vinyl or allyl group). The silyl hydride functionality reacts with the carbon-carbon unsaturated bond, typically in the presence of a hydrosilylation catalyst, to join across the unsaturated bond. The silyl hydride containing reactant can be a polysiloxane and/or the carbon-carbon unsaturated group containing reactant can be polysiloxane. ZnO particles as described herein can be dispersed in the polysiloxane of either or both reactant to form a composition within the scope of the present invention. That is, the silyl hydride functional reactant can be a polysiloxane with ZnO particles as described herein dispersed therein at a concentration as described herein to form a composition of the present invention. Alternatively, or additionally, the carbon-carbon unsaturated bond containing reactant can be a polysiloxane with ZnO particles as described herein dispersed therein at a concentration as described herein to form a composition of the present invention. When a hydrosilylation reaction system reacts to form a hydrosilylation reaction product that is a polysiloxane, the reaction product can be a composition of the present invention if it has ZnO particles as described herein dispersed within the polysiloxane reaction product.

Examples of suitable silyl hydride functional polysiloxanes for use as reactive polysiloxanes in a hydrosilylation reaction system include dimethyl, methyl hydrogen siloxane, trimethylsiloxy terminated (CAS number 68037-59-2), hydrogen terminated dimethyl siloxane (CAS number 70900-21-9), hydrogen terminated dimethyl methylhydrogen siloxane (CAS number 690113-23-6), trimethylsiloxy terminated polymethylhydrosiloxanes (CAS number 63148-57-2), triethylsiloxy terminated polyethylhydrosiloxane (CAS number 24979-95-1), and hydride terminated methylhydrosiloxane-phenylmethylsiloxane copolymer (CAS number 115487-49-5).

Examples of suitable carbon-carbon unsaturated bond containing polysiloxanes for use as reactive polysiloxanes in a hydrosilylation reaction system include vinyl terminated polydimethylsiloxane (CAS number 68083-19-2), 2,4,6,8-tetramethyl-2,4,6,8-tetravinylcyclotetrasiloxane (CAS Number 2554-06-5), dimethylcyclics with tetrakis(vinyldimethylsiloxy)silane (CAS number 316374-82-0), Vinyl Terminated Diphenylsiloxane-Dimethylsiloxane Copolymers (CAS number 68951-96-2), Vinyl Terminated TrifluoropropylMethylsiloxane-Dimethylsiloxane Copolymer (CAS number 68951-98-4), Vinylmethylsiloxane-Dimethylsiloxane Copolymers, trimethylsiloxy terminated (CAS number 67762-94-1), Vinylmethylsiloxane-Dimethylsiloxane Copolymers, vinyl terminated (CAS number 68083-18-1), Vinylmethoxysiloxane Homopolymer (CAS number 131298-48-1).

Hydrosilylation reaction catalysts are well known in the art, any of which can be used in a hydrosilylation reaction system comprising a composition of the present invention, including as a component in a composition of the present invention. Suitable hydrosilylation reaction catalysts include transition metals (such as platinum, rhodium, palladium) based catalyst. Examples of hydrosilylation catalysts include platinum-based Speier's catalyst, platinum-based Karstedt's catalyst, and rhodium-based Wilkinson's catalyst. One particularly desirable catalyst is 1,3-diethenyl-1,1,3,3 tetramethyldisiloxane platinum complex commercially available as DOWSIL™ 4000 Catalyst (DOWSIL is a trademark of The Dow Chemical Company).

Another example of a reactive system that can contain reactive polysiloxanes and/or that can generate polysiloxane reaction products is a condensation reaction system that reacts to produce a condensation reaction product. A condensation reaction system comprises a reactants with hydroxyl and/or alkoxy functionalities and often a condensation reaction catalyst. The reactants can include reactive polysiloxanes. Reactive polysiloxanes having hydroxyl and/or alkoxy functionalities can be combined with ZnO particles as described herein to form a condensation reaction reactant that is a composition of the present invention. When reactants of a condensation reaction system comprise ZnO particles and undergo condensation reaction the condensation reaction product can be a polysiloxane having the ZnO particles dispersed therein and, hence, can be a composition of the present invention.

Examples of suitable hydroxyl-functional polysiloxanes that can be reactants in condensation reaction systems include dimethyl siloxane, hydroxy-terminated (CAS number 70131-67-8); silanol terminated polydiphenylsiloxane (CAS number 63148-59-4); silanol-trimethylsilyl modified Q resins (CAS number 56275-01-5).

Examples of suitable alkoxy-functional polysiloxanes that can be reactants in condensation reaction systems include dimethyl siloxane, trimethoxysiloxy-terminated (CAS number 142982-20-5); dimethyl siloxane, mono-trimethoxysiloxy- and trimethylsiloxy-terminated (CAS number 472976-92-4); dimethyl siloxane, trimethylsiloxy-terminated (CAS number 63148-62-9).

Examples of suitable condensation reaction catalyst for condensation reaction systems include, in the broadest scope, any condensation reaction catalyst commonly known for use in condensation reactions. Typically condensation reaction catalysts are tin-based catalysts, acids, or bases. Examples of suitable tin-based catalysts include dibutyltin diacetate, carbomethoxyphenyl tin trisuberate, isobutyl tin triceroate, dimethyl tin dibutyrate, dibutyl tin diacetate, dibutyl tin dilaurate, di vinyl tin diacetate, dibutyl tin dibenzoate, dibutyl tin dioctoate, dibutyl tin dilactate, triethyl tin tartrate, tributyl tin acetate, triphenyl tin acetate, tricyclobhxyl tin acrylate, tritolyl tin terephthalate, tri-n-propyl acetate.

Surprisingly and unexpectedly, compositions of the present invention can achieve a V0 rating in UL94 testing without requiring typically known flame retardants. In contrast to polysiloxane flame retardant compositions taught in the art, the composition of the present invention can achieve a V0 rating in UL94 testing even when characterized by any one or any combination of more than one of the following:
(a) contain less than 10 wt % or even 5 wt % or less, 2 wt % or less, one wt % or less or even be free of halogenated compounds; and/or
(b) contain less than 30 vol % or even 20 vol % or less, 10 vol % or less, 5 vol % or less, 2 vol % or less, one vol % or less or even be free of metal hydrates; and/or
(c) contain less than 1.0 wt %, or even 0.75 wt % or less, 0.5 wt % or less, 0.25 wt % or less, 0.10 wt % or less or even be free of organo-complexes of platinum, rhodium and iridium; and/or
(d) be free of intumescent silicone rubber, or even be free of any intumescent package, where the intumescent silicone rubber and intumescent packages in general comprise a binder, a blowing agent and an acid source that foam upon heating to temperatures where the composition they are in is combustible; and/or
(e) be free of red phosphorous; and/or
(f) be free of silicates; and or
(g) contain 10 wt % or less, even 9 wt % or less, 8 wt % or less, 7 wt % or less, 5 wt % or less, 4.5 wt % or less, 4 wt % or less, 3.5 wt % or less, 3 wt % or less, 2 wt % or less, even one wt % or less flame retardant additive.

The composition of the present invention can be free of particulate additives other than the ZnO particles described herein or it can comprise particulate additives in addition to the ZnO particles described herein (“additional particulate additives”). For instance, the composition of the present invention can be free of metal oxides other than the ZnO particles described herein, or can further contain ZnO particles having a larger size than that described herein or can even contain metal oxides other than ZnO.

It is desirable for the composition of the present invention to be a thermally conductive composition, meaning it has a thermal conductivity of greater than 0.5 Watts per meter-Kelvin (W/m*K) as determine by the ISO 22007-2:2015 Part 2 test method as measured at 22° C. To enhance thermal conductivity, the composition of the present invention can comprise additional particulate additives that are thermally conductive particles such as any one or any combination of more than one thermally conductive fillers selected from a group consisting of silicon dioxide (SiO₂), aluminum, aluminum oxide (Al₂O₃), magnesium oxide (MgO), titanium dioxide (TiO₂), Zirconium dioxide (ZnO₂), aluminum nitride (AlN), silicon carbide (SiC), boron nitride (BN), aluminum trihydroxide (Al(OH)₃)), magnesium trihydroxide (Mg(OH)₃), calcium carbonate (CaCO₃), graphite, and clay.

When additional particulates additives, such as thermally conductive fillers, are present, they are typically present at a concentration of 95 wt % or less, 90 wt % or less, 85 wt % or less, 80 wt % or less, 75 wt % or less, 70 wt % or less, 65 wt % or less, 60 wt % or less, 55 wt % or less or even 50 wt % or less while at the same time are typically present at a concentration of 10 wt % or more, 20 wt % or more, 30 wt % or more, 40 wt % or more, 50 wt % or more, even 60 wt % or more relative to weight of the composition.

### EXAMPLES

### Hydrosilylation Examples

Table 1 identifies the components for use in the Hydrosilylation Examples of Exs 1-3 and Comp Exs A-H.

Prepare Part A and Part B composition as described in Tables 2 and 3 using a 10 liter Turello mixer.

For the Part A composition, load the specified amount of VFP1 into the mixer and mix for 5 minutes at 20 revolutions per minute (RPM) under nitrogen flow at 0.4 cubic meters per hour. Add the specified amounts of Quartz Powder, ZnO, Al₂O₃ and/or TiO₂ and stir for an additional 15 minutes. Heat to 80 degrees Celsius (° C.) under vacuum for one hour. Cool down to 22° C. and add the hydrosilylation catalyst.

For the Part B composition, load the specified amount of VFP1 into separate mixer pot and mix for 5 minutes at 20 RPM under nitrogen flow at 0.4 cubic meters per hour. Add the specified Quartz Powder and ZnO components and stir for an additional 15 minutes. Heat to 95° C. under vacuum for one hour. Cool to 22° C. and add the specified amount of VFP2 and SHFP1 and mix.

Blend equal weight parts of Part A and Part B to form a reactive mixture and cure at 70° C. for 30 minutes to obtain a hydrosilylation reaction product. Prepare hydrosilylation reaction product of each composition at thickness of 125+/−5 millimeters thick and at 13.0+/−0.5 millimeters thick. Prepare 10 samples of each thickness. Evaluate 5 of the samples immediately as fresh samples in UL 94 vertical orientation flame test. Age 5 of the samples at 70° C. for 168 hours to serve as “aged samples” and then subject to the UL 94 vertical orientation flame test. Flame test results are in Table 4.

Compositions and test results are provided below.

TABLE 1

| Component | Description | Source |
|---|---|---|
| Vinyl Functional | Vinyl dimethyl terminated polydimethylsiloxane | Commercially available as |
| Polysiloxane 1 | with nominal viscosity of 430 mPa*s and 0.42 | Gelest Product Code: DMS- |
| (VFP1) | wt % vinyl. | V25, CAS No: 68083-19-2 |
| | | from Gelest, 11 East Steel |
| | | Road, Morrisville, PA. 19067 |
| Vinyl Functional | 2,4,6,8-tetramethyl-2,4,6,8- | Commercially available from |
| Polysiloxane 2 | tetravinylcyclotetrasiloxane (CAS Number | Sigma-Aldrich. |
| (VFP2) | 2554-06-5). | |
| Silyl Hydride | Trimethyl terminated dimethyl-co-hydrogen | Commercially available from |
| Functional | methyl polysiloxane with nominal viscosity of 10 | Gelest under the product name |
| Polysiloxane 1 | mPa*s and 0.7 Wt. % Si H. (CAS number | HMS-501. |
| (SHFP1) | 68037-59-2) | |
| Nano-ZnO | ZnO particles having an average particle size of | Commercially available as |
| | 0.11-0.13 micrometers. | Zoco 102 from Zochem. |
| Micro-ZnO | ZnO particles having an average particle size of | Calcined Zinc Oxide from |
| | approximately 5 micrometers | Hakusui Tech Co., Ltd. |
| Nano Al₂O₃ | Al₂O₃ particle having an average particle size of | Commercially available as |
| | approximately 0.2 micrometers. | ASFP-20 from Denka |
| | | Company Limited of Japan |
| NanoTiO₂ | TiO₂ particle having an average particle size of | Commercially available under |
| | approximately 0.2 micrometers. | the name TIPAQUE ™ R630 |
| | | from Ishihara Sangyo Kaisha. |
| Hydrosilylation | 1,3-diethenyl-1,1,3,3 tetramethyldisiloxane | Commercially available as |
| Catalyst | platinum complex (CAS number 68478-92-2) | DOWSIL ™ 4000 Catalyst |
| | | from The Dow Chemical |
| | | Company |
| Carbon Black | Carbon black paste consisting of 50 wt % carbon | Commercially available as |
| | black in dimethyl siloxane, dimethylvinylsiloxy- | SILASTIC ™ CP-84 black |
| | terminated with nomial viscosity of 1950 mPa*s | pigment from The Dow |
| | and 0.23 wt % vinyl (average formula of | Chemical Company. |
| | M^{Vi}D₁₉₀M^{Vi}). | SILASTIC is a trademark of |
| | | Dow Corning Corporation. |
| Quartz Powder | Silica dioxide particles having an average | Commercially available as |
| | particle size of 2.2 micrometers and a BET | SilverBond CA 0020 from |
| | surface area of approximately 6.0 square | Sibelco Shanghai Minerals |
| | meters per gram. | Co., Ltd |

TABLE 2
Part A Formulations

| | Wt % of each Component in the Part A Composition | | | | | | |
|---|---|---|---|---|---|---|---|
| | [symbol] | | [symbol] | [symbol] | [symbol] | [symbol] | [symbol] |
| Sample | [symbol] | [symbol] | [symbol] | [symbol] | [symbol] | [symbol] | [symbol] |
| Comp Ex A | 0.24 | 37.76 | 62.00 | 0 | 0 | 0 | 0 |
| Comp Ex B | 0.24 | 37.76 | 61.70 | 0.30 | 0 | 0 | 0 |
| Comp Ex C | 0.24 | 37.76 | 61.00 | 1.00 | 0 | 0 | 0 |
| Comp Ex D | 0.24 | 37.76 | 61.90 | 0 | 0.10 | 0 | 0 |
| Ex 1 | 0.24 | 37.76 | 61.85 | 0 | 0.15 | 0 | 0 |
| Ex 2 | 0.24 | 37.76 | 61.70 | 0 | 0.30 | 0 | 0 |
| Ex 3 | 0.24 | 37.76 | 61.00 | 0 | 1.0 | 0 | 0 |
| Comp Ex E | 0.24 | 37.6 | 61.85 | 0 | 0 | 0.15 | 0 |
| Comp Ex F | 0.24 | 37.6 | 61.70 | 0 | 0 | 0.30 | 0 |
| Com Ex G | 0.24 | 37.6 | 61.85 | 0 | 0 | 0 | 0.15 |
| Com Ex H | 0.24 | 37.6 | 61.70 | 0 | 0 | 0 | 0.30 |

TABLE 3
Part B Formulations

| | Wt % of each Component in the Part B Composition | | | | | | | | |
|---|---|---|---|---|---|---|---|---|---|
| | | | [symbol] | | [symbol] | [symbol] | [symbol] | [symbol] | [symbol] |
| Sample | [symbol] | [symbol] | [symbol] | [symbol] | [symbol] | [symbol] | [symbol] | [symbol] | [symbol] |
| Comp | 6.00 | 31.10 | 62.00 | 0.40 | 0.50 | 0 | 0 | 0 | 0 |
| Ex A | | | | | | | | | |
| Comp | 6.00 | 31.10 | 61.70 | 0.40 | 0.50 | 0.30 | 0 | 0 | 0 |
| Ex B | | | | | | | | | |
| Comp | 6.00 | 31.10 | 61.00 | 0.40 | 0.50 | 1.00 | 0 | 0 | 0 |
| Ex C | | | | | | | | | |
| Comp | 6.00 | 31.10 | 61.90 | 0.40 | 0.50 | 0 | 0.10 | 0 | 0 |
| Ex D | | | | | | | | | |
| Ex 1 | 6.00 | 31.10 | 61.85 | 0.40 | 0.50 | 0 | 0.15 | 0 | 0 |
| Ex 2 | 6.00 | 31.10 | 61.70 | 0.40 | 0.50 | 0 | 0.30 | 0 | 0 |
| Ex 3 | 6.00 | 31.10 | 61.00 | 0.40 | 0.50 | 0 | 1.0 | 0 | 0 |
| Comp | 6.00 | 31.10 | 61.85 | 0.40 | 0.50 | 0 | 0 | 0.15 | 0 |
| Ex E | | | | | | | | | |
| Comp | 6.00 | 31.10 | 61.70 | 0.40 | 0.50 | 0 | 0 | 0.30 | 0 |
| Ex F | | | | | | | | | |
| Comp | 6.00 | 31.10 | 61.85 | 0.40 | 0.50 | 0 | 0 | 0 | 0.15 |
| Ex G | | | | | | | | | |
| Comp | 6.00 | 31.10 | 61.70 | 0.40 | 0.50 | 0 | 0 | 0 | 0.30 |
| Ex H | | | | | | | | | |

TABLE 4
UL 94 Vertical Flame Test Results

| | | | | After flame | | | |
|---|---|---|---|---|---|---|---|
| | | | | plus after | | | |
| | | | | glow time | After | | |
| | | After flame | Total after | for each | flame or | | |
| | | time for | flame time | individual | after glow | | |
| | | each | for any | specimen | of any | | |
| | | individual | condition | after the | specimen | Cotton | |
| | | specimen | set (t1 + t2 | second flam | up to the | indicator | |
| | | t1 or t2 | for the 5 | application | holding | ignited by | FR |
| Test Criteria | | (seconds) | specimens) | (t2 + t3) | clamp | flaming | level |
| V0 Target values | | ≤10 | <50 | <30 | No | No | V0 |
| Comp Ex A | Fresh | ≤8 | 39 | 7 | No | No | V1 |
| | Aged | ≤22 | 101 | 25 | No | No | |
| Comp Ex B | Fresh | ≤8 | 35 | 6 | No | No | V1 |
| | Aged | ≤24 | 97 | 18 | No | No | |
| Comp Ex C | Fresh | ≤9 | 37 | 8 | No | No | V1 |
| | Aged | ≤20 | 88 | 19 | No | No | |
| Comp Ex D | Fresh | ≤7 | 32 | 8 | No | No | V1 |
| | Aged | ≤16 | 77 | 15 | No | No | |
| Ex 1 | Fresh | ≤6 | 26 | 6 | No | No | V0 |
| | Aged | ≤8 | 36 | 8 | No | No | |
| Ex 2 | Fresh | ≤6 | 25 | 7 | No | No | V0 |
| | Aged | ≤8 | 28 | 6 | No | No | |
| Ex 3 | Fresh | ≤5 | 21 | 6 | No | No | V0 |
| | Aged | ≤6 | 23 | 6 | No | No | |
| Comp Ex E | Fresh | ≤7 | 45 | 7 | No | No | V1 |
| | Aged | ≤17 | 95 | 17 | No | No | |
| Comp Ex F | Fresh | ≤5 | 30 | 2 | No | No | V1 |
| | Aged | ≤22 | 78 | 22 | No | No | |
| Comp Ex G | Fresh | ≤7 | 42 | 7 | No | No | V1 |
| | Aged | ≤12 | 75 | 8 | No | No | |
| Comp Ex H | Fresh | ≤8 | 44 | 3 | No | No | V1 |
| | Aged | 15 | 82 | 11 | No | No | |

Comp Ex A demonstrates that in the absence of ZnO the compositions fail to achieve a V0 rating. Comp Exs B and C demonstrate that even at a loading of 1 wt % micro-ZnO the composition still cannot achieve a rating of V0. Comp Ex D demonstrates that a loading of 0.1 wt % nano-ZnO is insufficient to achieve a rating of V0. Exs 1-3 demonstrate that nano-ZnO at a loading as little as 0.15 wt % (Ex 1) and on up to one wt % achieve a rating of V0. It is evident from the values that increasing the loading of nano-ZnO further will continue to achieve a rating of V0.

Comp Exs E and F demonstrate that nano-Al₂O₃ does not enable achieving the V0 rating like nano-ZnO even at loadings of 0.30 wt %. Similarly, Comp Exs G and H demonstrate that nano-TiO₂ does not enable achieving the V0 rating like nano-ZnO even at loadings of 0.30 wt %.

Aluminum Oxide Filled Hydrosilylation Systems

Table 5 discloses the components used to prepare Comp Ex I and Ex 4.

Comp Ex I and Ex 4

Prepare Part A and Part B composition as described in Tables 6 and 7 using a 10 liter Turello mixer. Prepare Comp Ex I and Ex 4 by blending 1:1 weight ratios of the corresponding Part A and Part B compositions and curing at 120° C. for 60 minutes to obtain a hydrosilylation reaction product. Prepare hydrosilylation reaction product of each composition at thickness of 125+/−5 millimeters thick and at 13.0+/−0.5 millimeters thick. Prepare 10 samples of each thickness. Evaluate 5 of the samples immediately as fresh samples in UL 94 vertical orientation flame test. Age 5 of the samples at 70° C. for 168 hours to serve as “aged samples” and then subject to the UL 94 vertical orientation flame test. Flame test results are provided below in Table 8.

TABLE 5

| Component | Description | Source |
|---|---|---|
| Vinyl Functional | Vinyl dimethyl terminated polydimethylsiloxane | Commercially available as |
| Polysiloxane 3 | with nominal viscosity of 2000 mPa*s and 0.24 | DMS-V31 from Gelest |
| (VFP3) | wt % vinyl. | |
| Vinyl Functional | Vinyl dimethyl terminated polydimethylsiloxane | Commercially available as |
| Polysiloxane 4 | with nominal viscosity of 78 mPa*s and 1.25 | DMS-V21 from Gelest |
| (VFP4) | wt % vinyl. | |
| Treating Agent 1 | n-decyltrimethoxysilane | Commercially available as |
| (TA1) | | SID2670.0 from Gelest |
| Treating Agent 2 | Polydimethylsiloxane, monotrimethoxysiloxy | This material can be |
| (TA2) | and trimethylsiloxy terminated, having an | synthesized according to the |
| | average molecular structure of | teachings in US2006/0100336. |
| | (CH₃)₃SiO((CH₃)₂SiO)₁₁₀Si(OCH₃)₃. | |
| 2-micrometer | Aluminum oxide particles having an average | Available from Sumitomo |
| Al₂O₃ | particle size of 2-micrometers. | Chemical Co., Ltd of Japan as |
| | | ALM-41-01. |
| 60-microemter | Aluminum oxide particles having an average | Available from ZhengZhou |
| Al₂O₃ | particle size of 60-micrometers. | Light Metals Research Institute |
| | | of CHIALCO as A-SF-60. |
| Nano-ZnO | ZnO particles having an average particle size of | Commercially available as |
| | 0.11-0.13 micrometers. | Zoco 102 from Zochem. |
| Platinum | 1,3-diethenyl-1,1,3,3 tetramethyldisiloxane | Commercially available as |
| Catalyst | platinum complex (CAS number 68478-92-2) | SYL-OFF ™ 4000 Catalyst |
| | | from The Dow Chemical |
| | | Company. SYL-OFF is a |
| | | trademark of Dow Corning |
| | | Corporation. |
| Carbon Black | Carbon black pigment | Commercially available as |
| (CB) | | DOWSIL ™ 8-0084 Pigment |
| | | from The Dow Chemical |
| | | Company. |
| Blue Pigment | Proprietary blue pigment | Commercially available from |
| (Blue) | | Harwick Stantone as 40SP03 |
| Cure Inhibitor | Methyl(tris(1,1-dimethyl-2-propynyloxy))silane | Available from Alfa Chemistry. |
| Crosslinker | Trimethyl terminated dimethyl-co-hydrogen | Commercially available as |
| (XL1) | methyl polysiloxane with nominal viscosity of 19 | J < S-071 from Gelest. |
| | mPa*s and 0.11 mole-percent SiH. | |
| Crosslinker | Trimethyl terminated dimethyl-co-hydrogen | Commercially available as |
| (XL2) | methyl polysiloxane with nominal viscosity of 14 | HMS-301 from Gelest. |
| | mPa*s and 0.36 mol % SiH. | |

Comp Ex I

For the Part A composition, load the specified amount of vinyl polysiloxanes and treating agents into the mixer and mix for 5 minutes at 20 revolutions per minute (RPM) under nitrogen flow at 0.4 cubic meters per hour. Add half of the 2-micrometer sized aluminum oxide filler while mixing and continue mixing for 10 minutes at 45 RPM under nitrogen purge.

Add the remaining 2-micrometer aluminum oxide filler and mix for 10 minutes at 45 RPM under nitrogen purge. Stop mixing and scrape material down from the walls of the mixing container and cover. Heat to 60° C. Add half of the 60 micrometer sized aluminum oxide particle and mix for 10 minutes at 45 RPM under nitrogen purge. Add the rest of the 60-micrometer sized aluminum oxide particles and mix for 10 minutes at 45 RPM under nitrogen purge. Stop mixing and scrape material down from the walls of the mixing container. Continue mixing for 60 minutes at 45 RPM under vacuum. Heat to 130° C. and mix at 45 RPM under vacuum for 30 minutes. Cool to 40° C., stop mixing and release vacuum. Scrape material down from the container wall and mixer blade. Add the platinum catalyst component and mix for 15 minutes at 45 RPM under nitrogen purge then for 30 minutes under vacuum. Stop mixing and release the vacuum to obtain the Part A composition for Comp Ex I.

For Part B, Load the vinyl polymers, blue pigment, carbon black and filler treating agents into the mixer container. Mix at 20 RPM under a nitrogen purge of 0.4 cubic meter per hour. Add half of the 2-micrometer aluminum oxide filler and mix at 45 RPM under nitrogen purge for 10 minutes. Add the rest of the 2-micrometer aluminum oxide filler and mix for 10 minutes at 45 RPM under nitrogen purge. Stop mixing and scrape material down the contain sides. Heat to 60° C. and add half of the 60-micrometer aluminum oxide filler and mix for 10 minutes at 45 RPM under nitrogen purge. Add the remaining 60-micrometer aluminum oxide filler and mix for 10 minutes at 45 RPM under nitrogen purge. Stop mixing and scrape material down the wall of the container. Mix for 60 minutes at 45 RPM under vacuum. Heat to 130° C. and mix at 45 RPM under vacuum for 30 minutes. Cool to 40° C., release the vacuum and scrape material down from the container sides. Add the cure inhibitor, chain extender and crosslinker and mix for 15 minutes at 45 RPM under nitrogen purge. Mix for 30 minutes at 45 RPM under vacuum. Stop mixing and release vacuum to obtain Part B composition for Comp Ex I.

Ex 4

For the Part A composition, load the specified amount of vinyl polymer and treating agents into the mixer and mix for 5 minutes at 20 revolutions per minute (RPM) under nitrogen flow at 0.4 cubic meters per hour. Add the Nano-ZnO and half of the 2-micrometer sized aluminum oxide filler while mixing and continue mixing for 10 minutes at 45 RPM under nitrogen purge. Add the remaining 2-micrometer aluminum oxide filler and mix for 10 minutes at 45 RPM under nitrogen purge. Stop mixing and scrape material down from the walls of the mixing container and cover. Add half of the 60 micrometer sized aluminum oxide particle and mix for 10 minutes at 45 RPM under nitrogen purge. Add the rest of the 60-micrometer sized aluminum oxide particles and mix for 10 minutes at 45 RPM under nitrogen purge. Stop mixing and scrape material down from the walls of the mixing container. Continue mixing for 60 minutes at 45 RPM under vacuum. Heat to 130° C. and mix at 45 RPM under vacuum for 30 minutes. Cool to 40° C., stop mixing and release vacuum. Scrape material down from the container wall and mixer blade. Add the platinum catalyst component and mix for 15 minutes at 45 RPM under nitrogen purge then for 30 minutes under vacuum. Stop mixing and release the vacuum to obtain the Part A composition for Ex 4.

For Part B, Load the vinyl polymers, and filler treating agents into the mixer container. Mix at 20 RPM under a nitrogen purge of 0.4 cubic meter per hour. Add the Nano-ZnO and half of the 2-micrometer aluminum oxide filler and mix at 45 RPM under nitrogen purge for 10 minutes. Add the rest of the 2-micrometer aluminum oxide filler and mix for 10 minutes at 45 RPM under nitrogen purge. Stop mixing and scrape material down the contain sides. Add half of the 60-micrometer aluminum oxide filler and mix for 10 minutes at 45 RPM under nitrogen purge. Add the remaining 60-micrometer aluminum oxide filler and mix for 10 minutes at 45 RPM under nitrogen purge. Stop mixing and scrape material down the wall of the container. Mix for 60 minutes at 45 RPM under vacuum. Heat to 130° C. and mix at 45 RPM under vacuum for 30 minutes. Cool to 40° C., release the vacuum and scrape material down from the container sides. Add the Add the cure inhibitor, chain extender and crosslinker and mix for 15 minutes at 45 RPM under nitrogen purge. Mix for 30 minutes at 45 RPM under vacuum. Stop mixing and release vacuum to obtain Part B composition for Ex 4.

TABLE 6
Part A Formulations

| | Wt % of each Component in the Part A Composition | | | | | | | |
|---|---|---|---|---|---|---|---|---|
| | | | [symbol] | [symbol] | [symbol] | [symbol] | | [symbol] |
| Sample | [symbol] | [symbol] | [symbol] | [symbol] | [symbol] | [symbol] | [symbol] [symbol] | [symbol] |
| Comp Ex I | 0.29 | 7.06 | 0.38 | 0.37 | 39.03 | 52.78 | 0 | 0.09 |
| Ex 4 | 0.29 | 7.06 | 0.38 | 0.37 | 26.39 | 52.78 | 12.64 | 0.09 |

TABLE 7
Part B Formulations

| | Wt % of each Component in the Part B Composition | | | | | | | | | | | |
|---|---|---|---|---|---|---|---|---|---|---|---|---|
| | [symbol] | [symbol] | | | [symbol] | [symbol] | [symbol] | [symbol] | [symbol] | | | |
| Sample | [symbol] | [symbol] | [symbol] | [symbol] | [symbol] | [symbol] | [symbol] | [symbol] | [symbol] | [symbol] | [symbol] | [symbol] |
| Comp | 0.47 | 4.14 | 0.18 | 1.58 | 0.38 | 0.33 | 39.03 | 52.78 | 0 | 0.15 | 0.33 | 0.004 |
| Ex I | | | | | | | | | | | | |
| Ex 4 | 0.47 | 4.14 | 0.18 | 1.58 | 0.38 | 0.33 | 26.39 | 52.78 | 12.64 | 0.15 | 0.33 | 0.004 |

TABLE 8
UL 94 Vertical Flame Test Results

| | | | | After flame | | | |
|---|---|---|---|---|---|---|---|
| | | | | plus after | | | |
| | | | | glow time | After | | |
| | | After flame | Total after | for each | flame or | | |
| | | time for | flame time | individual | after glow | | |
| | | each | for any | specimen | of any | | |
| | | individual | condition | after the | specimen | Cotton | |
| | | specimen | set (t1 + t2 | second flam | up to the | indicator | |
| | | t1 or t2 | for the 5 | application | holding | ignited by | FR |
| Test Criteria | | (seconds) | specimens) | (t2 + t3) | clamp | flaming | level |
| V0 Target values | | ≤10 | ≤50 | ≤30 | No | No | V0 |
| Comp Ex I | Fresh | ≤15 | 59 | 68 | No | No | V1 |
| | Aged | ≤23 | 54 | 57 | No | No | |
| Ex 4 | Fresh | 0 | 0 | 3 | No | No | V0 |
| | Aged | 0 | 0 | 2 | No | No | |

The results of Comp Ex I and Ex 4 illustrate that Al₂O₃ filler alone does not achieve a V0 rating, but replacing some Al₂O₃ with nano-sized zinc oxide Ex 4 achieves the V0 rating.

### Condensation Examples

Table 9 identifies the components for use in the Condensation Examples.

Prepare Part A and Part B compositions as described in Tables 10 and 11. Blend equal volume parts of the Part A and Part B compositions for each Comp Ex and Ex through a 2-part cartridge with a static mixer to form a 3 millimeter thick reactive mixture on polytetrafluoroethylene film and cure at 23° C. (for how long? Any particular level of humidity needed?). Cut ten samples from each composition for UL 94 vertical flame testing. Evaluate five of the sample immediately as “fresh” samples. Age five of the samples at 70° C. for 168 hours prior to UL 94 testing as “aged” samples. Flame test results are in Table 12.

Comp Ex J demonstrates that in the absence of the nano-ZnO the composition is unable to achieve the V0 rating. Exs 5-7 demonstrate that including the nano-ZnO into the composition enables the compositions to achieve V0 rating.

TABLE 9

| Component | Description | Source |
|---|---|---|
| Al₂O₃-1 | Aluminum oxide particles having an average particle | Commercially available |
| | size of approximately 40 micrometers. | as DAM40K from |
| | | DENKA company. |
| Al₂O₃-2 | Aluminum oxide particles having an average particle | Commercially available |
| | size of approximately 2 micrometers. | as ALM-41-01 from the |
| | | Sumitomo Chemical |
| | | Co., Ltd. |
| Al₂O₃-3 | Aluminum oxide particles having an average particle | Commercially available |
| | size of approximately 0.4 micrometers | as P172LSB from Alteo |
| | | Company of France |
| Nano-ZnO | ZnO particles having an average particle size of | Commercially available |
| | 0.11-0.13 micrometers. | as Zoco 102 from |
| | | Zochem. |
| Hydroxy- | Polydimethyl siloxane having a terminal hydroxyl | Commercially available |
| functionalized | functionality on each end and having an average | as DMS-S32, CAS NO |
| polysiloxane | molecular weight of 36,000 Daltons and a viscosity | 70131-67-8 from |
| (HFPS) | of 2,000 cSt. | Gelest. |
| Pigment | Pigment masterbatch prepared from vinyl terminated | Available as DMS-V31 |
| | polydimethylsiloxane | from Gelest (50 wt. %) |
| | | and BAYFERROX |
| | | 130 M available from |
| | | Bayferrox, Germany |
| Trimethoxysilylethylene | Polydimethyl siloxane having three terminal | Prepare according to |
| Alkoxy functionalized | methoxy functionalities on each end and having an | the teachings of |
| polysiloxane (AFPS-1) | average molecular weight of 13,000 Daltons | US4898910 |
| nDTMS | n-decyltrimethoxysilane. CAS number 5575-48-4 | Available from Sigma- |
| | | Aldrich. |
| 3-APTMS | 3-aminopropyl trimethoxy silane. CAS number | Available from Sigma- |
| | 13822-56-5 | Aldrich. |
| 1,6-TMSH | 1,6-Bis(trimethoxysilyl)hexane. CAS number | Available from Gelest |
| | 87135-01-1 | |
| 3-TMSPA | Bis(3-trimethoxysilylpropyl)amine. CAS number | Available from Sigma- |
| | 82985-35-1 | Aldrich. |
| Tin Catalyst | Dimethyltin dineodecoanoate. CAS number | Available from Gelest |
| | 68928-76-7 | |

TABLE 10
Part A Formulations

| | Wt % of each Component in the Part A Composition | | | | | |
|---|---|---|---|---|---|---|
| Sample | [symbol] | [symbol] | [symbol] | [symbol] | [symbol] | [symbol] |
| Comp Ex J | 55 | 21.5 | 8 | 0 | 15.4 | 0.1 |
| Ex 5 | 55 | 21.5 | 8 | 1 | 14.4 | 0.1 |
| Ex 6 | 55 | 21.5 | 8 | 3 | 12.4 | 0.1 |
| Ex 7 | 53.3 | 20.7 | 7.5 | 3 | 15.4 | 0.1 |

TABLE 11
Part B Formulations

| | Wt % of each Component in the Part B Composition | | | | | | | | |
|---|---|---|---|---|---|---|---|---|---|
| | | | [symbol] | [symbol] | [symbol] | [symbol] | [symbol] | [symbol] | [symbol] |
| Sample | [symbol] [symbol] | [symbol] | [symbol] | [symbol] | [symbol] | [symbol] | [symbol] | [symbol] | [symbol] [symbol] |
| Comp | 9.5 | 0.4 | 32.44 | 55.44 | 0 | 0.8 | 1.2 | 0.2 | 0.015 |
| Ex J | | | | | | | | | |
| Ex 5 | 8.5 | 0.4 | 24.94 | 55.95 | 8 | 0.8 | 1.2 | 0.2 | 0.01 |
| Ex 6 | 8.5 | 0.4 | 24.94 | 55.95 | 8 | 0.8 | 1.2 | 0.2 | 0.01 |
| Ex 7 | 8.5 | 0.4 | 24.94 | 55.95 | 8 | 0.8 | 1.2 | 0.2 | 0.01 |

TABLE 12
UL 94 Vertical Flame Test Results

| | | | | After flame + | After | | |
|---|---|---|---|---|---|---|---|
| | | After flame | Total after | after glow | flame or | | |
| | | time for | flame time | time for each | after glow | | |
| | | each | for any | specimen | of any | | |
| | | individual | condition | after the | specimen | Cotton | |
| | | specimen | set (t1 + t2 | second flame | up to the | indicator | |
| | | t1 or t2 | for the 5 | application | holding | ignited by | FR |
| Test Criteria | | (seconds) | specimens) | (t2 + t3) | clamp | flaming | level |
| V0 Target values | | ≤10 | ≤50 | ≤30 | No | No | V0 |
| Comp Ex J | Fresh | ≤11 | ≤66 | 19 | No | No | V1 |
| | Aged | ≤15 | ≤70 | 20 | No | No | |
| Ex 5 | Fresh | ≤8 | ≤32 | 11 | No | No | V0 |
| | Aged | ≤10 | ≤42 | 11 | No | No | |
| Ex 6 | Fresh | ≤10 | ≤39 | 9 | No | No | V0 |
| | Aged | ≤10 | ≤35 | 11 | No | No | |
| Ex 7 | Fresh | ≤9 | ≤36 | 9 | No | No | V0 |
| | Aged | ≤8 | ≤27 | 8 | No | No | |

1. A composition comprising: (a) a polysiloxane; and (b) 0.15 weight-percent or more and 85 weight-percent of less, relative to composition weight dispersed in the polysiloxane, of zinc oxide particles having an average particle size of less than one micrometer and greater than one nanometer as determined as the volume weighted median value of particle diameter distribution using a laser diffraction particle size analyzer, wherein the zinc oxide particles are free of surface treatment.

2. The composition of claim 1, wherein the polysiloxane is a reactive polysiloxane that comprises one or any combination of more than one functional group selected from a group consisting of silanol groups, alkoxy groups, epoxy groups, silyl hydride groups and groups containing carbon-carbon unsaturated bonds.

3. The composition of claim 1, wherein the composition is selected from a hydrosilylation reaction system, a hydrosilylation reaction product, a polysiloxane condensation reaction system and a polysiloxane condensation reaction product.

4. The composition of claim 2, wherein the composition further contains a platinum or tin catalyst.

5. The composition of claim 1, wherein the composition further comprises 50-95 weight-percent, based on composition weight, of a thermally conductive filler selected from a group consisting of SiO₂, Aluminum, Al₂O₃, MgO, TiO₂, ZrO₂, AlN, SiC, BN, Al(OH)₃, Mg(OH)₃, CaCO₃, graphite, clay or any combination thereof.

6. (canceled)

7. The composition of claim 1, wherein the concentration of the zinc oxide powder is in a range of 0.15 to 4.5 weight-percent relative to composition weight.

8. The composition of claim 1, wherein the composition contains less than 10 weight-percent flame retardant based on composition weight.

9. The composition of claim 1, wherein the composition contains less than 10 weight-percent, relative to composition weight, of halogenated compounds; less than 30 volume-percent, relative to composition volume, of metal hydrates, less than 1.0 weight-percent, relative to composition weight, of organo-complexes of platinum, rhodium and iridium; is free of red phosphorous, and that is free of intumescent silicone rubber formulations that comprise a binder, a blowing agent and an acid source that foam upon heating to temperatures where the composition is combustible.

10. The composition of claim 1, wherein the polysiloxane is part of a reactive system or is the reaction product of a reaction system.
